(19) United States
(12) Patent Application Publication
(10) Pub. No.: US 2008/0001376 A1
(43) Pub. Date: Jan. 3, 2008

(54) Shock absorber

(76) Inventor: Man Hee Jeong, Wonju-si (KR)

Correspondence Address: BACON & THOMAS, PLLC, 625 SLATERS LANE, FOURTH FLOOR, ALEXANDRIA, VA, 22314, US

(21) Appl. No.: 11/808,795

(22) Filed: Jun. 13, 2007

(30) Foreign Application Priority Data
Jun. 20, 2006 (KR) 10-2006-0056260

(51) Int. Cl. B60G 9/00; B60G 11/16

(52) U.S. Cl. 280/124.1; 280/124.179; 280/124.162

(57) ABSTRACT

Disclosed is a shock absorber which includes a shock transmission part having a lower end integrally coupled with a non-rotation wheel shaft of a tire and an upper end extending upward, a lever that is in contact with the impact transmission part at its one end and has a support pin at its center, and a shock attenuating part connected to the other end of the shock transmission part to attenuate impact applied to the lever through the shock transmission part during vertical movement of a vehicle. Therefore, an impact press point is moved to a center support pin of the lever as impact from the tire of the vehicle to a spring is increased. As a result, a spring constant is increased in proportion to movement of the pressing contact point, namely, by setting a small spring constant to the small impact, and a large spring constant to the large impact. Accordingly, although a smoother spring than a conventional spring is used, it is possible to appropriately deal with the impact amount from the tire in real time to offer both ride comfort and safety to a passenger, and a designer can obtain a desired magnitude of repulsive force within a preset impact range through inclination adjustment of a curved surface of the impact transmission part.

### FIELD OF THE INVENTION

The present invention relates to a shock absorber, and more particularly, to a shock absorber capable of providing both ride comfort and safety to a passenger.

### BACKGROUND OF THE INVENTION

Generally, a vehicle is provided with a suspension device as means for mitigating various impacts that may be generated during its running.

Such a suspension device includes a chassis spring for connecting an axle to a vehicle body and mitigating impact applied from a road surface, a shock absorber for absorbing free vibrations of the spring, and a stabilizer for preventing lateral swing of the vehicle body.

In addition, a rigid axle suspension, which has been most widely used as the suspension device, connects both tires using a single axle and supports the vehicle body through a spring. Examples of this may include a laminated leaf spring, a coil spring, an air spring, and so on.

However, the spring used as the conventional suspension device has a fixed spring constant. Specifically, since the spring constant is always fixed regardless of variation of impact amount transmitted through the tire, a soft spring has good ride comfort, but the vehicle body may be rolled at a curved road due to a centrifugal force to cause safety problems. On the other hand, a strong spring is resistive to various external impacts such as impact transferred from the tire or rolling of the vehicle body, but the ride comfort may be degraded.

That is, it is impossible to obtain both satisfactory ride comfort and safety through the use of any conventional spring.

Hereinafter, the reason that cannot obtain both satisfactory ride comfort and safety using the conventional spring with fixed spring constant will be described in detail.

One of laws of physics about spring properties is Hooke's Law F=kx where k is a spring constant.

For example, when a soft spring is used, a vehicle has a good ride comfort due to small vertical amplitude during running on a relatively smooth road surface. However, since the vertical amplitude of the vehicle body is increased on a tough road, a force applied to the spring becomes much strong in proportion to it. Therefore, in order to attenuate the impact in the spring itself, the spring'should have an extended length to secure a sufficient shock absorbing distance.

However, in case the spring has an extended length, the shock absorbing distance is prolonged to make ride comfort excellent, while the vehicle may be excessively pitched and may be rolled outward on a curved road, thereby considerably lowering safety of the vehicle. Moreover, a space for accommodating the long spring should be secured, which renders spatial utilization of the vehicle body disadvantageous.

On the contrary, when a strong spring is used to secure safety, it can securely deal with the vertical amplitude and the lateral rolling of the vehicle body to provide stability. However, since the external impacts are transmitted directly to the vehicle body through the spring, the ride comfort may be deteriorated.

Meanwhile, since a small vehicle or a truck may have a large difference between an unloaded weight in a stop state and a gross weight in a running state, it is difficult to adjust spring strength in proportion to the vehicle weight. For this reason, the small vehicle or the truck should use a relatively strong spring, which further decreases the ride comfort.

As a way to solve the problem to some degree, there has been proposed an air spring.

This air spring complies with Boyle-Charles's Law (PV/T=constant), not Hooke's Law, in terms of its properties, and therefore, it may be easier to secure ride comfort and stability compared with a steel spring.

Examples of a steel spring and an air spring will be described below to know a difference therebetween.

For example, when a steel spring retractable to 37 cm is prepared to support a weight of 5 tons, if a retracted length of the spring is 17 cm due to the weight, the remaining retractable length is 20 cm.

Then, when 1 ton is added to the steel spring, the remaining retractable length is 16.6 cm according to Hooke's Law. When 2 tons is added to the steel spring, the remaining retractable length is 13.2 cm, when 3 tons is added, the remaining retractable length is 9.8 cm, and when 4 tons is added, the remaining retractable length is 6.4 cm.

Similarly, when an appropriate air spring (cylinder type) supports a weight of 5 tons, a height of the air is 20 cm. Then when 1 ton is added, the height is reduced to 16.6 cm according to Boyle-Charles's Law, when 2 tons is added, the height is reduced to 14.3 cm, when 3 tons is added, the height is reduced to 12.5 cm, and when 4 tons is added, the height is reduced to 11.1 cm. The resultant graph is shown as follows.

As can be seen from the graph, the steel spring is retracted in proportion to the applied load, while the retracted length of the air spring is gradually reduced. Although both the steel spring and the air spring are equally deformed to 3.4 cm when 1 ton is added, when 4 tons is added, the retracted length of the steel spring is 13.6 cm, while that of the air spring is only 8.9 cm.

Reviewing properties by materials of the springs, they may be analyzed as follows. That is, it can be understood that the air spring has a larger stability than the steel spring even if they are designed to offer the same ride comfort.

The reason for this is that the spring constant of the air spring is gradually increased as the compression proceeds, while the steel spring maintains the same spring constant value regardless of the degree of compression.

There is still no clear theory of a repulsive force of a suspension device for a vehicle. Therefore, regarding the relationship between a shock absorbing distance and a repulsive force of an ideal suspension device on the basis of real road conditions and experimental numerals, it is preferred that the suspension device can be smoothly operated within a range of initial 2 cm, and operated to absorb all impacts within a range of approximately 5 to 6 cm even if a large impact is applied like when a vehicle rides over a speed bump.

Since most actual road surfaces have a height of unevenness within 1 cm, it is possible to improve ride comfort if the spring is smoothly operated when a bounce height of a tire of a vehicle is within 2 cm. If the repulsive force of the spring is strong from the time the shock absorbing distance exceeds 2 cm to absorb impact equal to the impact when a vehicle rides over the speed bump at the total shock absorbing distance of 5 to 6 cm (when the conventional vehicles rides over the speed bump), the rolling of the vehicle may be sufficiently suppressed.

Variation of the repulsive force of the spring for this ideal shock absorbing operation will be represented as shown in the following graph.

In the above graph, a section of the graph adjacent to an X-axis represents a section where the vehicle maintains an excellent ride comfort, and the other section, that is, an abruptly increasing section represents that there is little rolling of the vehicle when the vehicle runs on a curved road. In conclusion, the conventional steel spring or air spring cannot realize rapid variation of the repulsive force of the spring as shown in the above graph.

### SUMMARY OF THE INVENTION

Therefore, the present invention has been made in view of the above problems of the prior arts, and it is a primary object of the present invention to provide a shock absorber capable of providing both ride comfort and safety to a passenger by appropriately dealing with impact applied from the tire though a smoother spring desired by a designer is used, wherein a press point with which the lever contacts is moved to a center support pin along a circular arc of curved surface based on a leverage principle that the spring is installed at one end thereof on the basis of the center support point and the impact transmission part is disposed at the other end and by using the impact transmission of a curved surface structure.

In accordance with the present invention for achieving the above object, there is provided a shock absorber including: a shock transmission part having a lower end integrally coupled with a non-rotation wheel shaft of a tire and an upper end extending upward; a lever that is in contact with the impact transmission part at its one end and has a support pin at its center; and a shock attenuating part connected to the other end of the shock transmission part to attenuate impact applied to the lever through the shock transmission part during vertical movement of a vehicle.

### BRIEF DESCRIPTION OF THE DRAWINGS

The above and other objects and features of the instant invention will become apparent from the following description of preferred embodiments taken in conjunction with the accompanying drawings, in which:

FIG. 1 is a view schematically showing a lever and a contact point moving principle applied to a shock absorber of the present invention;

FIG. 2 is a graph showing the relationship between a force and a displacement when the shock absorber of the present invention is applied;

FIG. 3 is a schematic view of a shock absorber according to an embodiment of the present invention, which is divided into two parts of before and after shock absorbing operation;

FIG. 4 is a schematic view of a shock absorber according to another embodiment of the present invention, which is divided into two parts of before and after shock absorbing operation;

FIG. 5 is a schematic view of a shock absorber according to still another embodiment of the present invention, which is divided into two parts of before and after shock absorbing operation;

FIG. 6 is a schematic view of a shock absorber according to still another embodiment of the present invention using a hinge bar instead of the lever, which is divided into two parts of before and after shock absorbing operation; and

FIG. 7 is a schematic view of a shock absorber according to with still another embodiment of the present invention, particularly of an installation example of the shock absorber in a narrow space.

### DETAILED DESCRIPTION OF THE INVENTION

First, a principle that a spring constant is varied by a lever of the present invention and variation of a contact point will be explained, prior to describing preferred embodiments according to the present invention.

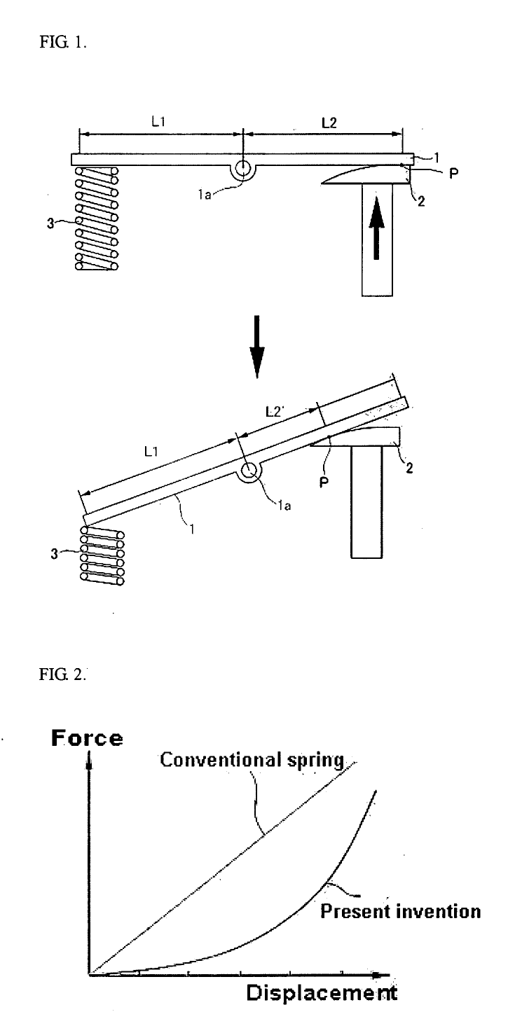

As shown in FIG. 1, an impact transmission part 2 is disposed at a lower surface of one end of a lever 1 to transmit impact from a tire, and a spring 3 is disposed at a lower surface of the other end of the lever 1 to attenuate the impact, with a center support pin 1a interposed therebetween.

In addition, an upper end of the impact transmission part 2 is smoothly curved downward toward the support pin 1a of the lever 1.

Meanwhile, in order to describe the leverage principle, it may be assumed that an operation in which a vehicle body is lowered by vertical amplitude of the vehicle body to apply load to the lever 1 is reaction in which impact from the tire is applied through the impact transmission part 2 to raise the lever 1.

With reference to only FIG. 1 based on this principle of force, it can be seen that press from the tire drives the impact transmission part 2 to raise the lever 1 such that the lever 1 presses a spring 3 during the press and at the same time, a pressing contact point P between the impact transmission part 2 and the lever 1 is moved toward the support pin 1a.

That is, although a distance L1 between the support pin 1a and the spring 3 is not varied, a distance L2 between the support pin 1a and the pressing contact point P is varied to L2′.

In other words, while the length L2 is reduced to L2′ in proportion to movement of the lever 1 raised by the impact transmission part 2, the spring constant may be gradually increased in proportion to the movement.

To be more specific, it can be recognized that the spring corresponds to small vertical amplitude of the vehicle body as a small spring constant, and corresponds to large vertical amplitude of the vehicle body as a large spring constant.

Meanwhile, FIG. 2 is a graph schematically showing variation of a repulsive force of the shock absorber obtained when using a soft spring based on the continuously varying leverage principle.

Hereinafter, various embodiments according to the present invention will be described on the basis of the leverage principle and the contact point moving principle.

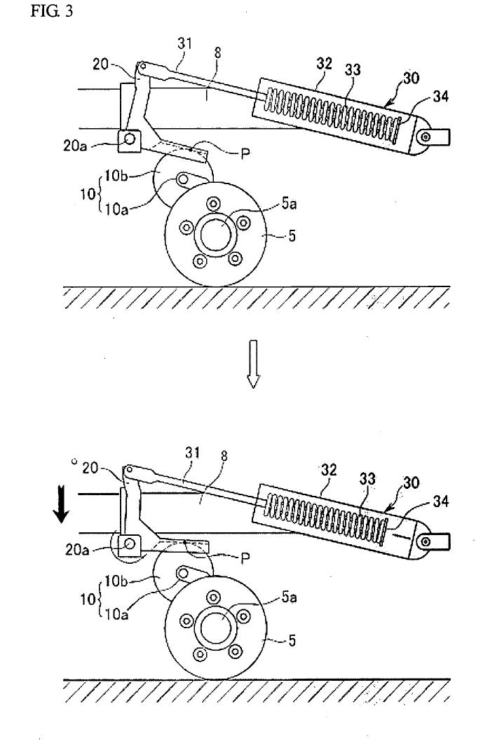

As shown in FIG. 3, a shock absorber according to an embodiment of the present invention includes an impact transmission part 10 having a lower end integrally coupled with a non-rotation wheel shaft 5a of a tire 5 and an upper end extending upward, a lever 20 that is in contact with the impact transmission part 10 at its one end and has a support pin 20a at its center, and a shock attenuating part 30 connected to the other end of the lever 20 to attenuate impact applied to the lever 20 through the impact transmission part 10 during vertical movement of the vehicle.

Here, the impact transmission part 10 is constituted by a rotary support bracket 10a having a lower end integrally coupled with the non-rotation wheel shaft 5a of the tire 5 and an upper end bent toward the lever 20, and a rotary disc body 10b rotatably and axially coupled with the rotary support bracket 10a and axially rotated depending on press against the lever 20, to move a pressing contact point P with the lever 20 toward the support pin 20a.

The lever 20, especially, a lower end of the lever 20 that is in contact with the rotary disc body 10b preferably has a “ [symbol] ” shape to cover an upper end of an outer periphery of the rotary disc body 10b, to thereby prevent separation from each other.

The impact attenuation part 30 is constituted by a rod 31 hinged to the other end of the lever 20 opposite to the impact transmission part 10, a cylinder 32 for covering the rod 31 such that the rod 31 reciprocates through one end thereof and hinged at the other end, a spring 33 surrounding an outer periphery of the rod 31 disposed inside the cylinder 32, and a support plate 34 coupled with the other end of the rod 31 exposed to the exterior of the spring 33.

In the shock absorber according to an embodiment of the present invention having the structure described above, when the tire bounds by unevenness of the road surface, the lever 20 is pushed upward by the rotary disc body 10b of the impact transmission part 10 and at the same time an upper end of the lever 20 is rotated counterclockwise about the support pin 20a to pull the rod 31 of the impact attenuation part 30. Thus, the spring 33 in the cylinder 32 is compressed by the support plate 34, so that the lever 20 has a resilient repulsive force through the rod 31.

Meanwhile, as the press of the rotary disc body 10b proceeds, the pressing contact point P with the lever 20 moves toward the support pin 20a of the lever 20 so that the spring constant is gradually increased to appropriately deal with the impact from the tire.

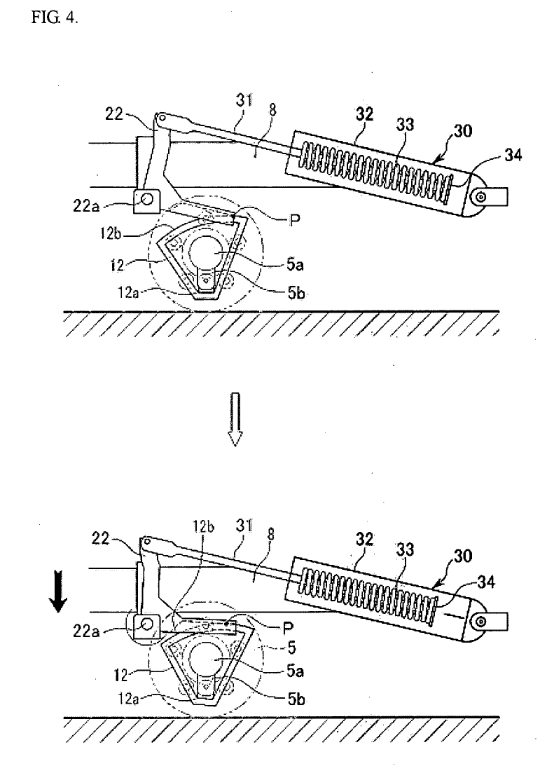

FIG. 4 illustrates a shock absorber according to another embodiment of the present invention, which shows a method for saving a vertical space required to install the shock absorber. A bent structure of a lever 22 and a structure of an impact attenuation part 30 are the same as that of FIG. 3, but a structure of an impact transmission part 12 is somewhat different from that of FIG. 3.

The impact transmission part 12 having the different structure is constituted by a separate hinge bracket 5b formed at a lower surface of a non-rotation wheel shaft 5a of a tire 5, a hinge connection piece 12a formed at a lower end thereof and hinged to the hinge bracket 5b, and a curved part 12b formed at an upper end thereof in a convexly rounded shape and axially rotated according to press against the lever 22 to move a pressing contact point P with the lever 22 toward a support pin 22a.

Here, the impact transmission part 12 has a polygonal frame structure with a through-hole through which the non-rotation wheel shaft 5a passes. And, it has a hinge connection piece 12a projecting upward from a lower inner side surface thereof by a predetermined distance and having a segmental plate shape. The hinge bracket 5b corresponding to the polygonal frame is constituted by a pair of segmental pieces spaced apart from a predetermined distance and hinged to each other to cover both sides of the hinge connection piece 12a.

The reason for forming the impact transmission part in the polygonal shape is as follows. In the case that a distance between the support pin 22a of the lever 22 and an the pressing contact point P is about 15 cm, when it is desired to make a shock absorbing distance short, since a distance from the curved surface 12b of the impact transmission part 12 to the hinge connection piece 12a may exceed 20 cm which is varied depending on its design, there is a need to save a vertical space because a small rotational angle is allowable for operation.

In the shock absorber according to another embodiment of the present invention having the structure set forth above, when the tire bounds, the lever 22 is pushed upward by the curved surface 12b of the impact transmission part 12 and at the same time an upper end of the lever 22 is rotated counterclockwise about the support pin 22a to pull the rod 31 of the impact attenuation part 30. Thus, the spring 33 in the cylinder 32 is compressed by the support plate 34, so that the lever 22 has a resilient repulsive force through the support plate 34.

Meanwhile, while the press against the curved surface 12b proceeds, the impact transmission part 12 is rotated leftward about the hinge connection piece 12a, and at the same time, the pressing contact point P with the lever 22 moves toward the support pin 22a of the lever 22 so that the spring constant is gradually increased to appropriately deal with the impact from the tire.

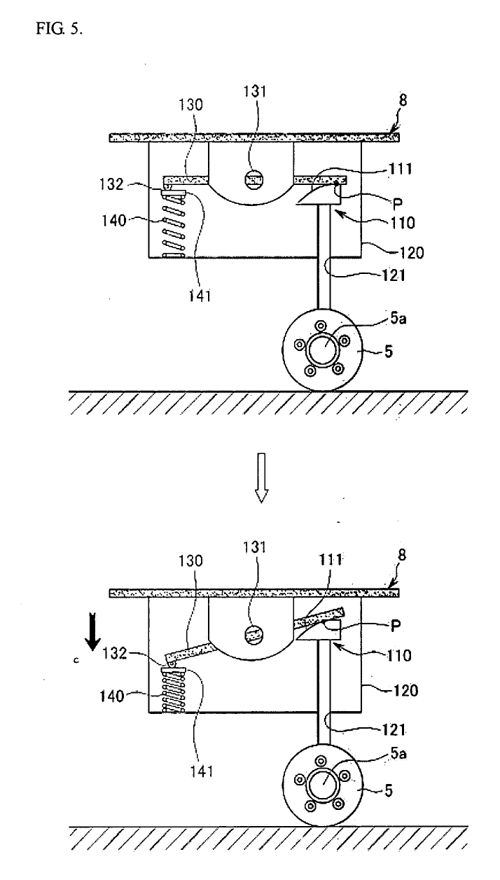

FIG. 5 illustrates a shock absorber according to still another embodiment of the present invention. The shock absorber is constituted by an impact transmission part 110 having a lower end directly connected to a tire 5 and an upper end extending upward, a housing 120 having a through-hole 121 formed at a lower surface thereof and through which the upper end of the impact transmission part 110 passes at a lower surface thereof and fixed to a vehicle body 8 at its outer surface, a lever 130 that is in contact with the impact transmission part 110 at a lower surface of one end thereof and has a support pin 131 at its center, and a spring 140 closely disposed between a lower surface of the other end of the lever 130 and a bottom surface of the housing 120.

Here, a curved surface 111 is formed on an upper surface of the impact transmission part 110 and smoothly rounded toward the support pin 131 to move a pressing contact point P with the lever 130 toward the support pin 131 as press against the lever 130 proceeds.

In addition, a roller 132 is installed at a lower surface of the lever 130 for pressing the spring 140, and a rolling plate 141 is additionally installed at an upper end of the spring 140 corresponding to the roller 132 such that the roller 132 rolls on the rolling plate 141 to press the spring 140.

In the shock absorber according to still another embodiment of the present invention having the structure described above, lowering of the vehicle body 8 causes the impact transmission part 110 to relatively push the lever 130 upward, and at the same time, an opposite end of the lever 130 on the basis of the support pin 131 to press the spring downward, thereby generating a resilient repulsive force to attenuate impact from the tire.

It can also be seen that the pressing contact point P between the impact transmission part 110 and the lever 130 is moved toward the support pin 131 to attenuate the impact.

Meanwhile, on pressing the spring 140, the roller 132 of the lever 130 rolls on the rolling plate 141 to smoothly press the spring 140.

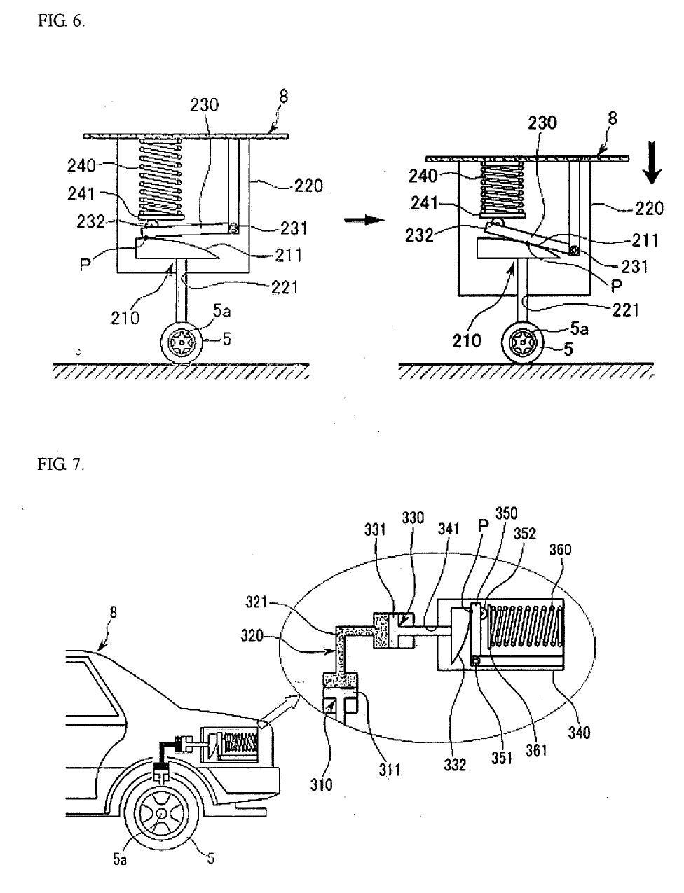

FIG. 6 illustrates a shock absorber according to still another embodiment of the present invention. The shock absorber includes an impact transmission part 210 having a lower end directly connected to a non-rotation wheel shaft 5a of a tire 5 and an upper end extending upward, a housing 220 having a through-hole 221 formed at a lower surface thereof and through which the upper end of the impact transmission part 210 passes and fixed to a vehicle body 8 at its outer surface, a hinge bar 230 that is in contact with the impact transmission part 210 at a lower surface of one end thereof and has a hinge shaft 231 hinged to the other end, and a spring 240 closely disposed between an upper surface of the one end of the hinge bar 230 and an upper surface of the housing 220.

Here, a curved surface 211 is formed on an upper surface of the impact transmission part 210 and smoothly rounded toward the hinge shaft 231 to move a pressing contact point P with the hinge bar 230 toward the hinge shaft 231 as press against the hinge bar 230 proceeds.

In addition, a roller 232 is installed at an upper surface of the hinge bar 230 for pressing the spring 240, and a rolling plate 241 is additionally installed at a lower end of the spring 240 corresponding to the roller 232 such that the roller 232 rolls on the rolling plate 241 to press the spring 240.

The shock absorber according to still another embodiment of the present invention having the structure set forth above utilizes the hinge bar 230 hinged at its one end without using the level, unlike other embodiments using it, and the impact transmission part 210 and the spring 240 are disposed on the lower surface and the upper surface of the other end of the hinge bar 230, respectively. This structure is different from that of the above-described embodiments.

Meanwhile, in operation, lowering of the vehicle body 8 causes the curved surface 211 of the impact transmission part 210 moves toward the hinge shaft 231 in a contact manner to pull the hinge bar 230 upward, and therefore, the hinge bar 230 also raises the spring 240 to generate a resilient repulsive force, thereby attenuating the impact.

Here, as the press against the impact transmission part 210 proceeds, the pressing contact point P with the hinge bar 230 also moves toward the hinge shaft 231 to relatively increase the spring constant.

Meanwhile, on pressing the spring 240, the roller 232 of the hinge bar 230 rolls on the rolling plate 241 to smoothly press the spring 240.

FIG. 7 illustrates a shock absorber according to still another embodiment of the present invention. The shock absorber includes a first impact transmission part 310 having a lower end directly connected to a non-rotation wheel shaft 5a of a tire 5 and having a first piston part 311 formed at its upper end, a cylinder 320 covering the first piston part 311 of the first impact transmission part 310, filled with a hydraulic fluid 321 therein, and having an upper part bent at a right angle to a side part of the vehicle body 8, a second impact transmission part 330 having a second piston part 331 formed at its one end, accommodated in an upper end of the cylinder 320, disposed between the first piston part 311 and the hydraulic fluid 321 of the first impact transmission part 310, the other end being exposed to the exterior of the cylinder 320, a housing 340 having a through-hole 341 formed at a side surface thereof and through which one end of the second impact transmission part 330 passes and fixed to the vehicle body 8 at its outer surface, a hinge bar 350 that is in contact with one end of the second impact transmission part 330 at its one surface and has a hinge shaft 351 hinged to its lower end, and a spring 360 closely disposed between the other side surface of the hinge bar 350 and a sidewall surface of the housing 340.

Here, a curved surface 332 is formed on one end of the second impact transmission part 330 and rounded toward the hinge shaft 351 to move a pressing contact point P with the hinge bar 350 toward the hinge shaft 351 as press against the hinge bar 350 proceeds.

In addition, a roller 352 is installed at one surface of the hinge bar 350 for pressing the spring 360, and a rolling plate 361 is additionally installed at one end of the spring 360 corresponding to the roller 352 such that the roller 352 rolls on the rolling plate 361 to press the spring 360.

In this embodiment, the housing 340 including the spring 360 functioning as the impact attenuation part can be applied to a small vehicle having a small installation space. The housing 340 is bent toward a rear trunk of the vehicle at a right angle or other marginal spaces, and the cylinder 320 containing the hydraulic fluid 321 is interposed therebetween to transmit the impact from the tire 5 to the spring 360.

That is, when the first piston part 311 of the first impact transmission part 310 receives the impact from the tire 5 and pushes the hydraulic fluid 321 upward, the second piston part 331 of the second impact transmission part 330 bent toward the rear part of the vehicle at a right angle is pushed back by the hydraulic fluid 321 to press the spring 360 disposed in the housing 340, thereby generating a resilient repulsive force to attenuate the impact.

Such an installation structure of the shock absorber is more advantageous than that of FIG. 6 in improving ride comfort.

Here, the press against the second impact transmission part 330 moves the pressing contact point P with the hinge bar 350 toward the hinge shaft 351 to relatively increase the spring constant.

Meanwhile, on pressing the spring 360, the roller 232 of the hinge bar 350 rolls on the rolling plate 361 to smoothly press the spring 360.

As can be seen from the foregoing, the shock absorber of the present invention can provide both ride comfort and safety to a passenger by appropriately dealing with impact applied from the tire though a smoother spring desired by a designer is used, wherein a press point with which the lever contacts is moved to a center support pin along a circular arc of curved surface based on a leverage principle that the spring is installed at one end thereof on the basis of the center support point and the impact transmission part is disposed at the other end and by using the impact transmission of a curved surface structure.

That is, while the shock absorber according to the present invention uses a steel spring, it is configured to exhibit an ideal repulsive force as shown in the above graphs, without shock absorption according to Hooke's Law. Therefore, it is possible to remarkably improve ride comfort and also prevent rolling phenomenon, even by using a smoother spring than the conventional suspension device. As a result, both excellent ride comfort and drive stability of a vehicle can be secured.

In addition, the entire shock absorption distance of the vehicle can be controlled, without degrading ride comfort, through the use of a method for inclination adjustment of the curved surface of the impact transmission part, i.e., a method for laterally lengthening or shortening the impact transmission part. Therefore, when the shock absorber according to the present invention is installed at a vehicle running on a tough road, it is expected that fatigue of a driver may be reduced and durability of the vehicle may be improved.

The method of implementing the ideal repulsive force as shown in the above graph can be performed by setting a pressing contact point P about 2 cm lower than a support pin 1a, 20a or 22a of a lever serving as its rotational axis toward a wheel when the shock absorber using a smooth spring desired by the designer is installed at the vehicle in a stop state.

For example, when a compression coil spring compressed to 20 cm by a vehicle's weight in a stop state is installed at the vehicle, a distance from the support pin 1a, 20a, or 22a of the lever to the pressing contact point P is 15 cm, and a radius of a circumferential surface 12b of the impact transmission part is set to about 20 cm, a shock absorbing distance was approximately 5 cm even when the vehicle rides over a speed bump.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A shock absorber comprising:
a shock transmission part 10 or 12 having a lower end integrally coupled with a non-rotation wheel shaft 5a of a tire 5 and an upper end extending upward;
a lever 20 or 22 that is in contact with the impact transmission part 10 or 12 at its one end and has a support pin 20a or 22a at its center; and
a shock attenuating part 30 connected to the other end of the shock transmission part 10 or 12 to attenuate impact applied to the lever 20 or 22 through the shock transmission part 10 or 12 during vertical movement of a vehicle.

2. The shock absorber according to claim 1, wherein the impact transmission part 10 comprises:
a rotary support bracket 10a integrally coupled with the non-rotation wheel shaft 5a of the tire 5; and
a rotary disc body 10b axially coupled with the rotary support bracket 10a and axially rotated depending on press against the lever 20 to move a pressing contact point P with the lever 20 toward the support pin 20a.

3. The shock absorber according to claim 2, wherein the lever 20 or 22 has a “ [symbol] ” shape with both ends being disposed perpendicular to each other on the basis of the support point 20a or 22a.

4. The shock absorber according to claim 3, wherein the impact attenuation part 30 comprises:
a rod 31 hinged to the other end of the lever 20 or 22 opposite to the impact transmission part 10 or 12;
a cylinder 32 for covering the rod 31 such that the rod 31 reciprocates through one end thereof and hinged at the other end;
a spring 33 surrounding an outer periphery of the rod 31 disposed inside the cylinder 32; and
a support plate 34 coupled with the other end of the rod 31 exposed to the exterior of the spring 33.

5. The shock absorber according to claim 1, wherein the impact transmission part 12 comprises:
a hinge bracket 5b formed at a lower surface of the non-rotation wheel shaft 5a of the tire 5, a hinge connection piece 12a formed at a lower end thereof and hinged to the hinge bracket 5b, and a curved part 12b formed at an upper end thereof in a convexly rounded shape and axially rotated depending on press against the lever 22 to move the pressing contact point P with the lever 22 toward the support pin 22a.

6. The shock absorber according to claim 5, wherein the lever 20 or 22 has a “ [symbol] ” shape with both ends being disposed perpendicular to each other on the basis of the support point 20a or 22a.

7. The shock absorber according to claim 6, wherein the impact attenuation part 30 comprises:
a rod 31 hinged to the other end of the lever 20 or 22 opposite to the impact transmission part 10 or 12;
a cylinder 32 for covering the rod 31 such that the rod 31 reciprocates through one end thereof and hinged at the other end;
a spring 33 surrounding an outer periphery of the rod 31 disposed inside the cylinder 32; and
a support plate 34 coupled with the other end of the rod 31 exposed to the exterior of the spring 33.

8. A shock absorber comprising:
an impact transmission part 110 having a lower end directly connected to a non-rotation wheel shaft 5a of a tire 5 and an upper end extending upward;
a housing 120 having a through-hole 121 formed at a lower surface thereof and through which the upper end of the impact transmission part 110 passes and fixed to a vehicle body 8 at its outer surface;
a lever 130 that is in contact with the impact transmission part 110 at a lower surface of one end thereof and has a support pin 131 at its center; and
a spring 140 closely disposed between a lower surface of the other end of the lever 130 and a bottom surface of the housing 120.

9. The shock absorber according to claim 8, wherein a roller 132 is installed at a lower surface of the lever 130 for pressing the spring 140, and a rolling plate 141 is further installed at an upper end of the spring 140 corresponding to the roller 132 such that the roller 132 rolls on the rolling plate 141 to press the spring 140.

10. The shock absorber according to claim 8, wherein a curved surface 111 is formed on an upper surface of the impact transmission part 110 in a round shape to move a pressing contact point P with the lever 130 toward the support pin 131 as press against the lever 130 proceeds.

11. A shock absorber comprising:
an impact transmission part 210 having a lower end directly connected to a non-rotation wheel shaft 5a of a tire 5 and an upper end extending upward;
a housing 220 having a through-hole 221 formed at a lower surface thereof and through which the upper end of the impact transmission part 210 passes and fixed to a vehicle body 8 at its outer surface;
a hinge bar 230 that is in contact with the impact transmission part 210 at a lower surface of one end thereof and has a hinge shaft 231 hinged to the other end; and
a spring 240 closely disposed between an upper surface of the one end of the hinge bar 230 and an upper surface of the housing 220.

12. The shock absorber according to claim 11, wherein a roller 232 is installed at an upper surface of the hinge bar 230 for pressing the spring 240, and a rolling plate (241) is further installed at a lower end of the spring 240 corresponding to the roller 232 such that the roller 232 rolls on the rolling plate 241 to press the spring 240.

13. The shock absorber according to claim 11, wherein a curved surface 211 is formed on an upper surface of the impact transmission part 210 in a round shape to move a pressing contact point P with the hinge bar 230 toward the hinge shaft 231 as press against the hinge bar 230 proceeds.

14. A shock absorber comprising:
a first impact transmission part 310 having a lower end directly connected to a non-rotation wheel shaft 5a of a tire 5 and having a first piston part 311 formed at its upper end;
a cylinder 320 covering the first piston part 311 of the first impact transmission part 310, filled with a hydraulic fluid 321 therein, and having an upper part bent at a right angle to a side part of a vehicle body 8;
a second impact transmission part 330 having a second piston part 331 formed at its one end, accommodated in an upper end of the cylinder 320, and disposed between the first piston part 311 and the hydraulic fluid 321 of the first impact transmission part 310, the other end being exposed to the exterior of the cylinder 320;
a housing 340 having a through-hole 341 formed at a side surface thereof and through which one end of the second impact transmission part 330 passes and fixed to the vehicle body 8 at its outer surface;
a hinge bar 350 that is in contact with one end of the second impact transmission part 330 at its one surface and has a hinge shaft 351 hinged to its lower end; and
a spring 360 closely disposed between the other side surface of the hinge bar 350 and a sidewall surface of the housing 340.

15. The shock absorber according to claim 14, wherein a roller 352 is installed at one side surface of the hinge bar 350 for pressing the spring 360, and a rolling plate 361 is further installed at one end of the spring 360 corresponding to the roller 352 such that the roller 352 rolls on the rolling plate 361 to press the spring 360.

16. The shock absorber according to claim 14, wherein a curved surface 332 is formed on one end of the second impact transmission part 330 in a round shape to move a pressing contact point P with the hinge bar 350 toward the hinge shaft 351 as press against the hinge bar 350 proceeds.
